(19) United States
(12) Patent Application Publication
(10) Pub. No.: US 2008/0189149 A1
(43) Pub. Date: Aug. 7, 2008

(54) METHOD, SYSTEM, AND PROGRAM PRODUCT FOR OPTIMIZING A WORKFORCE

(76) Inventors: Enrique Carrillo, Weston, FL (US); Elizabeth W. Pyatte, Dallas, TX (US)

Correspondence Address: HOFFMAN WARNICK LLC, 75 STATE ST, 14TH FLOOR, ALBANY, NY, 12207, US

(21) Appl. No.: 11/670,167

(22) Filed: Feb. 1, 2007

(51) Int. Cl. G06Q 10/00

(52) U.S. Cl. 705/7; 705/8

(57) ABSTRACT

The present invention optimizes a workforce for an organization as a whole or for a single project by determining what it will take so that just the right resource (R^{R}) can be applied to just the right need (R^{N}) at just the right time (R^{T}) at just the right place (R^{P}) and just the right cost (R^{C}). Out of this analysis emerged an equation to depict workforce optimization, using the elements of optimization (resource, need, time, place, and cost) as exponents to one side of the equation and the supply and demand balance as the other side of the equation. The result is an Optimization Equation, which can be depicted as follows: R^{R}+R^{N}+R^{T}+R^{P}+R^{C}=(S/D=1). This allows employees or “(workforce) resources” to be treated similar to widgets in an inventory management or supply chain.

### FIELD OF THE INVENTION

The present invention generally relates to workforce optimization. Specifically, the present invention relates to a method, system, and program product for optimizing a workforce for an organization as a whole or for a single project.

### BACKGROUND OF THE INVENTION

Leaders in business, government, and academia increasingly agree that the only way to create sustainable, competitive advantage in a world of relentless change and increased global competition is to innovate and find new ways to take advantage of their workforce. Categorizing employee competencies is something that has been done for years to document the skills of our workforce. Using this categorization of skills to fuel a tool with a suite of capabilities that enables us to view employees as a supply chain of labor, however, is definitely new. It is a world in which we can put just the right person, in just the right job, in just the right place, at just the right cost—no more or less than is needed at a particular point in time. Making this happen is no trivial matter. Success requires a delicate balancing act between having just the right size labor pool to meet current demand with the ability to nimbly expand to meet growth at a moment's notice. This is a balancing act that many companies seek to resolve

The Resource Revolution: As competition for goods and services increased in the 1990s, employees and managers alike took a new look at their obligations and opportunities. Not too many years ago, keeping track of who could do what, when, and where was quite simple for most companies. Managers knew their employees and their strengths and weaknesses. It did not matter that John's 2000 plus work hours each year were only utilized at 60% or that Sally's utilization was at 50%. These employees were valued and were part of the corporate family, so managers ignored, or simply did not think about, the lost opportunity to the bottom line that their collective 90% bench time cost the company. On the flip side, managers merely lamented when they lost a contract to a competitor because they did not have a certain set of skills at the ready to make available to the customer, at the right time and place and cost. They rationalized the loss as “something we do not do here or have the capability or capacity to do. We do what we do when we can do it. It has always been like this.”

At the time, the world of balancing the supply of labor with the demand for labor was not the central topic when bottom line discussions were had. The employee workforce was seen as a loyal team of many people who formed the face of the company. Load balancing, employee shifting, staffing up in one area, and staffing down in another: these conversations simply were not had. “Of course, we are going to keep John and Sally on the payroll. They have always been here. Their faces are part of our corporate composite picture.” The perception of an employee's utilization ruled over the reality, which at the time was not tracked in most companies. From the employee's point of view, their job was to show up each day and work if there was work and visit and do odd jobs if there was no work. Looking for utilization opportunities and being responsible for being utilized was the company's responsibility, not the employees'.

More recently, as globalization has occurred, companies merged, the information age burst onto the scene and competition for everything to be more flexible, responsive, smaller, better, and faster dawned, and competition for the lowest cost became the conversation of the day. Sitting on the bottom line of corporate balance sheets were large red flags waving the “cost of employees.” No longer could companies afford to keep the Johns and the Sallys of the world. Each and every employee had to pull his or her weight. The benefit that the employee brought to the company had to be at least three times that of their cost. Each and every skill that the employee brought to the table had to be in demand. Someone with skills that helped build the company of yesteryear was now at risk if those same skills were no longer needed. And as corporations began to wake up to the concept of total utilization of their workforce, layoffs began.

The following is an illustrative scenario: A manager in the UK lays-off Nigel in London, while across the city, another manager puts out an advertisement to hire someone with Nigel's exact skills, or sitting in a cubicle down the hall is someone who has 80% of the needed skills, who with a week's worth of training can be up-skilled to fill the gap.

Identifying those gaps and gluts in an organized fashion to date has been impossible, and the larger and more global the company, the harder it became to solve the problem. As such, knee jerk “resource actions” became the order of the day. The headlines blazed with thousands to be laid off in December—another four thousand are expected by March. The world of the loyal employee with the promise of a job from cradle to grave evaporated into thin air of “who would be the next to go.” With this changing climate, pensions were frozen, not offered, or recalculated. And a seismic shift occurred in the thinking of corporate employees: “I cannot depend on this company to take care of me, and it is now my responsibility to keep myself utilized in order to keep my job, and to save my own pension through 401 ks or whatever.” In answer, the companies said, “if we do not take strong measures to balance our labor with demand, we will not win in the marketplace, and the net result is that we just may not stay in business.”

In view of the foregoing, there exists a need for a solution to optimize the workforce in a way that addresses at least one of the above-referenced issues.

### SUMMARY OF THE INVENTION

The present invention addresses the aforementioned issues by first recognizing that each workforce resource (i.e., employee) comes with a matrix of attitudes, skills, knowledge, and experience. The invention leverages this knowledge to answer the question: What kind of system will it take so that just the right resource (R^{R}) can be applied to just the right need (R^{N}) at just the right time (R^{T}) at just the right place (R^{P}) and just the right cost (R^{C})? Out of this analysis emerged an equation to depict workforce optimization, using the elements of optimization (resource, need, time, place, and cost) as exponents on one side of the equation and the supply and demand balance as the other side of the equation. The result is an Optimization Equation, which can be depicted as follows: R^{R}+R^{N}+R^{T}+R^{P}+R^{C}=(S/D=1). This allows employees or “(workforce) resources” to be treated similar to widgets in an inventory management or supply chain.

A first aspect of the present invention provides a method for optimizing a workforce for an organization, comprising: determining a set of workforce variables; determining an organizational climate of the organization; interrelating the set of workforce variables and the organizational climate in an equation; and optimizing the workforce based on the equation.

A second aspect of the present invention provides a system for optimizing a workforce for an organization, comprising: a system for determining a set of workforce variables; a system for determining an organizational climate of the organization; a system for interrelating the set of workforce variables and the organizational climate in an equation; and a system for optimizing the workforce based on the equation.

A third aspect of the present invention provides a program product stored on a computer readable medium for optimizing a workforce for an organization, the computer readable medium comprising program code for causing a computer system to: determine a set of workforce variables; determine an organizational climate of the organization; interrelate the set of workforce variables and the organizational climate in an equation; and optimizing the workforce based on the equation.

A fourth aspect of the present invention provides a method for optimizing a workforce for an organization, comprising: deploying a computer infrastructure being operable to: determine a set of workforce variables; determine an organizational climate of the organization; interrelate the set of workforce variables and the organizational climate in an equation; and optimizing the workforce based on the equation.

A fifth aspect of the present invention provides computer software embodied in a propagated signal for optimizing a workforce for an organization, the computer software comprising instructions for causing a computer system to: determine a set of workforce variables; determine an organizational climate of the organization; interrelate the set of workforce variables and the organizational climate in an equation; and optimizing the workforce based on the equation.

A sixth aspect of the present invention provides a data processing system for optimizing a workforce for an organization, comprising: a memory medium, a bus coupled to the memory medium, a processor coupled to the bus, the memory medium comprising instructions that when executed by the processor cause the data processing system to: determine a set of workforce variables; determine an organizational climate of the organization; interrelate the set of workforce variables and the organizational climate in an equation; and optimizing the workforce based on the equation.

A seventh aspect of the present invention provides a computer-implemented business method for optimizing a workforce for an organization, comprising: determining a set of workforce variables; determining an organizational climate of the organization; interrelating the set of workforce variables and the organizational climate in an equation; and optimizing the workforce based on the equation.

Each of these aspects can be applied to an entire organization or to a single project within the organization. Each of these aspects can also include one or more of the following features: the set of organizational or project variables comprises a right resource, a right need, a right time, a right place, and a right cost; designating an integrator within the organization or project who is responsible for integrating the set of workforce; the workforce being optimized when the equation equals a value of 1.0; the workforce being optimized when ratio of workforce supply to workforce demand equals a value of 1.0; the organizational or project climate relating to a satisfaction level of the workforce.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a graph where supply is equal to demand according to the present invention.

FIG. 2 depicts a graph where a workforce equation is balanced according to the present invention.

FIG. 3 depicts a graph where a workforce equation is un-balanced according to the present invention.

FIG. 4 depicts a flow diagram of matching the right resources to the right need according to the present invention.

FIG. 5 depicts a flow diagram of matching the right resources to the right time according to the present invention.

FIG. 6 depicts a flow diagram of matching the right resources to the right place according to the present invention.

FIG. 7 depicts a flow diagram of matching the right resources to the right cost according to the present invention.

FIG. 8 shows a more detailed computerized implementation of the present invention.

FIG. 9 shows the linking of disciplines provided by the present invention.

FIG. 10 shows components of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience purposes, the Detailed Description of the Invention has the following sections:

I. General Description

II. Illustrative Example

III. Computerized Implementation

### I. General Description

As indicated above, the present invention addresses the aforementioned issues by first recognizing that each workforce resource (i.e., employee) comes with a matrix of attitudes, skills, knowledge, and experience. The invention leverages this knowledge to answer the question: What kind of system will it take so that just the right resource (R^{R}) can be applied to just the right need (R^{N}) at just the right time (R^{T}) at just the right place (R^{P}) and just the right cost (R^{C})? Out of this analysis emerged an equation to depict workforce optimization, using the elements of optimization (resource, need, time, place, and cost) as exponents to one side of the equation and the supply and demand balance as the other side of the equation. The result is a workforce optimization equation, which can be depicted as follows: ∫(R^{R}*+R^{N}*+R^{T}+R^{P}+R^{C})^{oc}=(S*/D*=1). This allows employees or “(workforce) resources” to be treated similar to widgets in an inventory management or supply chain. As will be further described below, the R^{R}, R^{N}, R^{T}, R^{P} and R^{C} are referred to herein as a set of workforce variables. These will be individually defined and described below.

The workforce optimization equation is a way to logically depict the delicate balance that a global organization or project must achieve if it is to have an optimized workforce, no more and no less than what is needed at any point in time. It can be difficult to convey the concept to customers and employees, and to convey the exponential magnitude of project and organizational decay when the right resources are not in balance with the supply and demand, which is often the key problem that forces many companies into bankruptcy and projects into ruin.

Typically, the answer to this equation must equal as close to a one-to-one ratio of supply versus demand as possible, and the optimization exponents must be a perfect match if a company is to efficiently and effectively utilize its workforce. What this means is that if a company does not get the “right resource” (R^{R}), for example, the first time, it will be twice as difficult to recover the second time. And the third time, it will be four times as difficult; and the fourth time, it becomes eight times as difficult, and so forth. Apply this logic to each expertise exponent in the equation, the challenge grows exponentially.

The ∫ in the workforce optimization equation is the component that represents the “integrator” of the end-to-end workforce. The symbol is based on the calculus symbol for calculating definite integrals, and we are using it here as an analogy of the mathematical process for sum affects of individual workforce optimization components over a total workforce organizational or project range. Although not depicted above, the integrator can range from “a-z” with “a” representing a lower limit and “z” representing an upper limit, in other words, from one end of the organizational or project supply chain to the other. In an organization or a project this is the person who has the responsibility for integrating all of the components in the workforce supply chain to achieve organizational or project balance, and hence is called the integrator. The ability to achieve workforce optimization (balance) can lead to organizational or project prosperity or decay. The title that the integrator would have in an organization or project might be Workforce Manager or Workforce Supply Chain Manager. Without the key role that the integrator plays, organizational or project balance would be a function of chance, instead of the result of implementing a calculated strategy to achieve balance. Therefore, under the present invention, an integrator would be designated.

The five R symbols represent the word Right. This means that each one of the five optimization components conform to fact, reason, truth, or some standard or principle. They are appropriate, equitable, fitting, lawful, legal, legitimate, merited, proper, suitable, and within the employee, customer, or financial standards, principles, guidelines, and goals set by the organization or project.

The R^{R} symbol represents the optimization component for the Right Resource. This means that the resources for the organization (or even for a single project) are perfectly matched to the requirements of the need for the resource. The capabilities of the Resource are a one-to-one match with the defined capabilities detailed by the need. This person or persons have the aptitude, bent, capability, capacity, competence, comprehension, expertise, facility, intelligence, power, proficiency, qualification, resourcefulness, skill, strength, talent, and understanding to perfectly match the need, which is expressed in the same terms. The actions of the Right Resource are exactly what should happen to achieve organizational or project proficiency. The greater the departure from the ideal equals the greater the risk for organizational or project decay.

The R^{N} symbol represents the optimization component for the Right Need. This means that the expression of what the organization (or even a single project) needs in terms of resources perfectly match to the capabilities of the Resources. The capabilities of the Need are a one-to-one match with the defined capabilities of the Resource. The Need is expressed by describing the Resource Requirements, which indicate the needed aptitude, bent, capability, capacity, competence, comprehension, expertise, facility, intelligence, power, proficiency, qualification, resourcefulness, skill, strength, talent, and understanding to perfectly match the Resource, which is expressed in the same terms. The actions of meeting the Right Need are exactly what has to happen to achieve organizational or project proficiency. The greater the departure from the ideal equals the greater the risk for organizational or project decay.

The R^{T} symbol represents the optimization component for the Right Time. This means that the expression of what the organization (or even a single project) needs in terms of resources perfectly match to the timing or availability of the Resources. The expressed capabilities of the Need are a one-to-one match with the defined capabilities of the Resource at exactly the Right Time. The actions of providing the Right Resource to meet the Right Need at the Right Time are exactly what has to happen to achieve organizational or project proficiency. The greater the departure from the ideal equals the greater the risk for organizational or project decay.

The R^{P} symbol represents the optimization component for the Right Place. This means that the expression of what the organization (or even a single project) needs in terms of resources perfectly match to the timing or availability of the Resources at exactly the Right Place. The Right Place is defined as the perfect area, locale, point, position, venue, virtual or actual, where the Right Resource needs to be to exactly meet the Right Need. The expressed capabilities of the Need are a one-to-one match with the defined capabilities of the Resource at exactly the Right Place. The actions of providing the Right Resource to meet the Right Need at the Right Place are exactly what has to happen to achieve organizational or project proficiency. The greater the departure from the ideal equals the greater the risk for organizational or project decay.

The R^{C} symbol represents the optimization component for the Right Cost. This means that the expression of what the organization (or even a single project) needs or can pay in terms of cost for the resource or resources perfectly matches the Right Cost of the Resources available at exactly the Right Place and Time. The Right Cost is defined as the perfect amount of money, investment, tariff, or exchange of services to be spent for the Right Resource that exactly meets the Right Need. The expressed capabilities of the Need are a one-to-one match with the defined capabilities of the Resource at exactly the Right Cost. The actions of providing the Right Resource to meet the Right Need at the Right Cost are exactly what has to happen to achieve organizational or project proficiency. The greater the departure from the ideal equals the greater the risk for organizational or project decay.

The O^{C} exponent symbol represents the optimization component for Organizational Climate, which is the collective perception and cognitive representation of the work environment by the Resources: it is how the Right Resource feels about working in the environment; it describes the collective attitudes and assumptions about their perception of the environment; and it also describes the shared perception of “how things work” in the environment, for good and for bad. A good Organizational Climate promotes high performance and personal fulfillment. A bad Organizational Climate does the opposite. Organizational Climate is an overarching measure of satisfaction that influences the entire equation. If an organization or a project does not have the Right Organizational Climate, then every other component is at risk of not being right anymore. An organization can have the Right Resource to meet the Right Need at the Right Time, Place, and Cost, and if the Organizational Climate is not right, then all of these optimization components are at risk of changing from Right to Wrong. The greater the departure from the ideal Organizational Climate equals the greater the risk for organizational or project decay.

The S symbol represents the optimization component for Supply, which indicates the total amount of Resources available for use in the organization (or even for a single project). The Supply of resources is expressed in terms that describe the capabilities of each resource. This storehouse contains the inventory of capability of an organization or project. It describes exactly what resources are available and delineates their capabilities, such as, aptitude, bent, capability, capacity, competence, comprehension, expertise, facility, intelligence, power, proficiency, qualification, resourcefulness, skill, strength, talent, and understanding.

The D symbol represents the optimization component for Demand, which indicates the total amount of Resources that are in demand in the organization or project. The Demand side for resources is expressed in terms that describe the capabilities of each resource that is in demand. The Demand for resources describes exactly what resources are needed and delineates their desired capabilities, such as, aptitude, bent, capability, capacity, competence, comprehension, expertise, facility, intelligence, power, proficiency, qualification, resourcefulness, skill, strength, talent, and understanding.

The asterisks (*) by four of the optimization components are a reference, indicating that they are taken from a common dictionary of skills, which we call the Expertise Taxonomy. It is critical that these optimization components be expressed using the exact same language. The Expertise Taxonomy, consequently, serves as the foundation of trusted terms of expertise data in a common language that will feed the method, system, and program product, that is the cross-organizational workforce application and tool, which provides resource information; thereby, unifying skill and expertise categories and dimensions, which results in increased efficiency and data integrity. The Workforce Optimization Equation would fail without a common taxonomy of trusted terms that is used by everyone in the end-to-end workforce supply chain. It would be impossible to find the Right Resource to meet the Right Need if the two were expressed using different terms and terminology. The same is true for the Supply and Demand side of the equation. Supply must be expressed using the same terminology as Demand if we are to have a one-to-one comparison that results in meaningful matches.

The right side of the equation means that the Total Supply divided by the Total Demand is in balance. When divided, they equal one. The greater the departure from the ideal balance of one to one equals the greater the risk for organizational or project decay. If the Demand for the Right Resources to meet the Right Need at the Right Time, Place, and Cost is greater than the organization's ability to Supply the Right Resources, then opportunities will be lost and could lead to organizational or project decay. On the other hand, if the Supply is greater than the Demand, then inefficiencies grow exponentially as Resources are underutilized, and this situation could lead to organizational or project decay.

The left side of the equation describes the collective nature of the Resource or Resources available in an organization or project. It describes a situation in which an organization or project must have the Right Resource available to meet the Right Need at exactly the Right Time, Place, and Cost. In the equation, these optimization components are expressed as exponents for a reason: the effects of not having it right are exponential. It takes twice as many resources to recover the first time, four times the second time, and eight times the third time, and so on. Compound that by adding the optimization components together, then one can quickly see that the impact is not only exponential, but the optimization components can differ in their degree of influence, further complicating the ability to balance the equation and get all the optimization components Right at the same time.

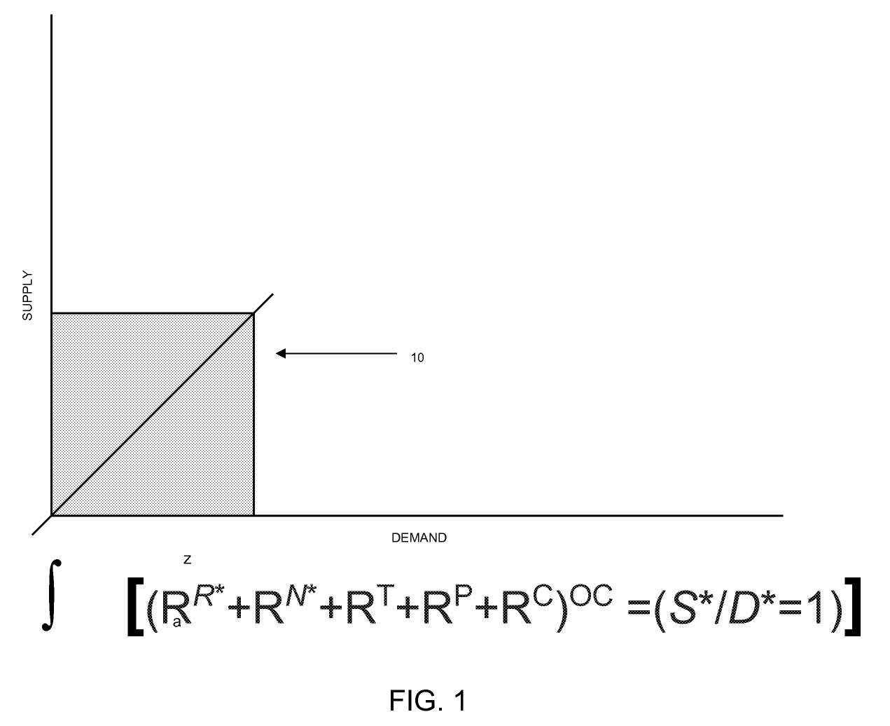

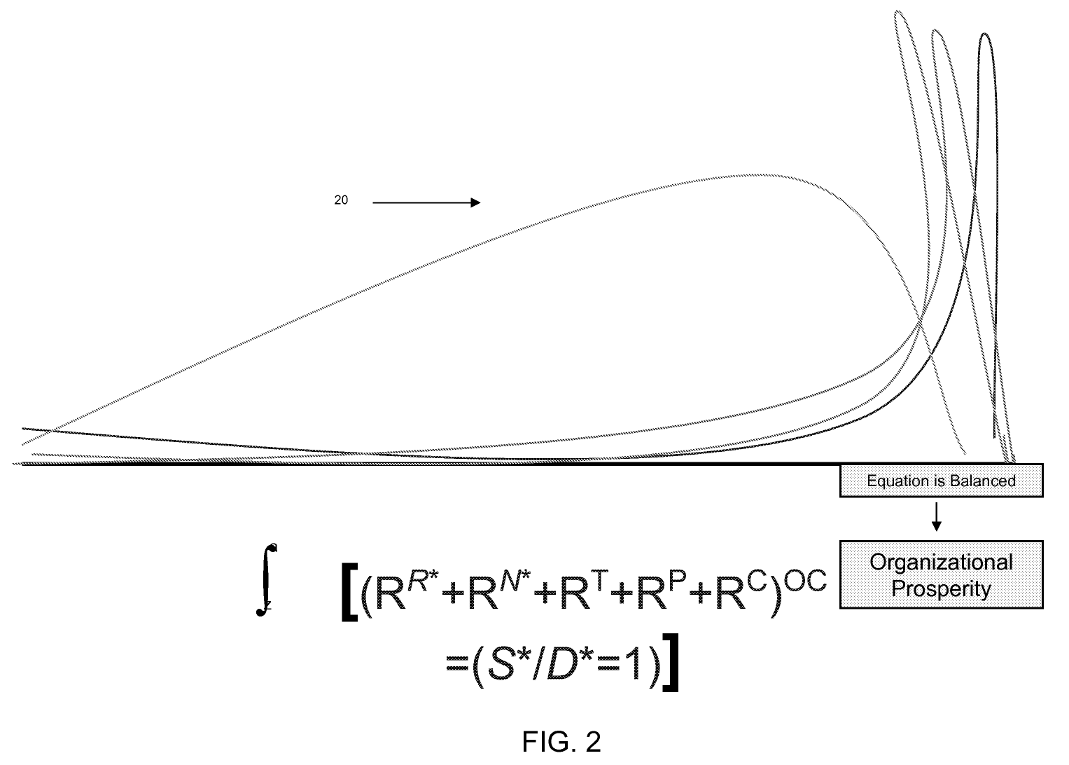

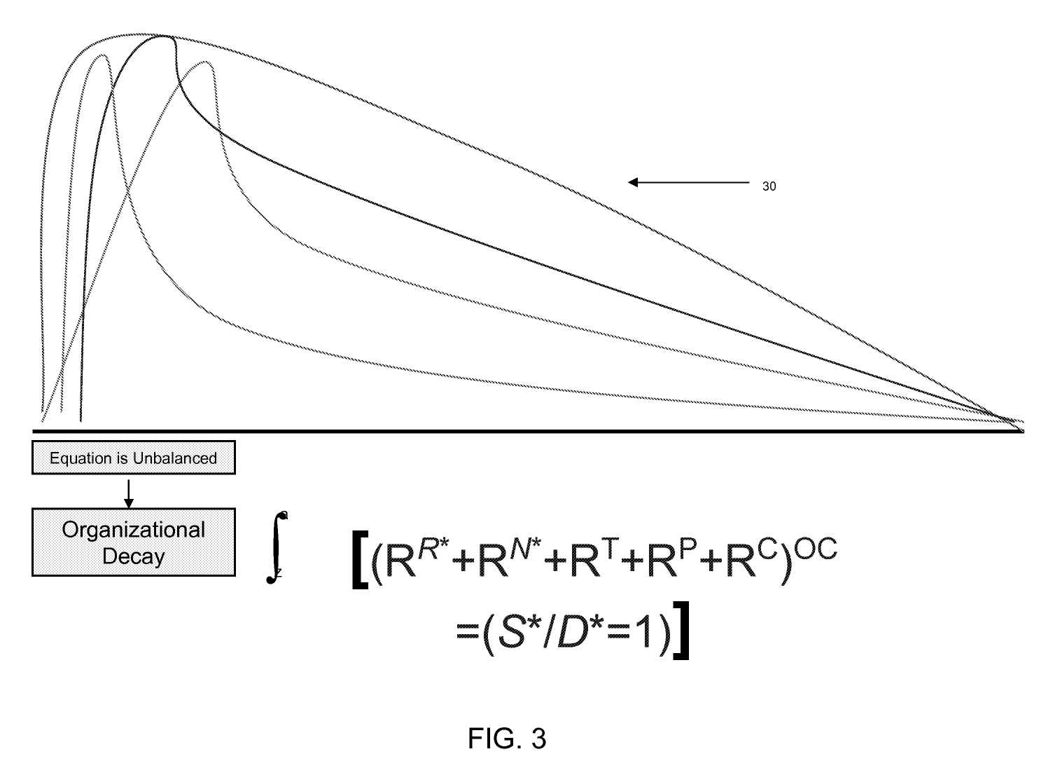

To achieve optimal Workforce Optimization, the two sides of the equation must be in perfect balance. The Supply must be available to meet the Demand, and the two must be in perfect balance (equaling one). An example of this is shown in FIG. 1, which shows a graph 10 where supply equals demand, which equals one. Just as important, the Right Resources must be available to meet the Right Need at the Right Time, Place, and Cost. What is more, the Organizational Climate must be positive or it can change the Right adjectives to Wrong. This equation is a picture of a perfectly balanced Workforce Supply Chain. And companies who are able to get this equation in balance are the ones who fall closer to the right side of the optimization curve. Referring to FIG. 2, a graph 20 of the workforce optimization equation being balanced is shown. Conversely, FIG. 3 shows a graph 30 of the workforce optimization equation being un-balanced.

### II. Illustrative Example

This section will set forth an illustrative example in which these teachings were applied to a “customer” by a “company” implementing the invention. It is important to note that in order to apply the Workforce Optimization Method, System, and Program Product to a single project, the Workforce Optimization Method, System, and Program Product should be in place for the entire organization in order to maximize efficiency and effectiveness. The illustrative example is explained from the company's point of view.

Assume in this example, that a major telecommunications customer called the company requesting that 200 hours of web-based training (WBT) be created in 8 weeks. The average time that it takes to create one hour of a typical WBT course is 120 hours; therefore, this project was going to be very complex, and is an example of how the workforce optimization equation could be used to communicate potential Organizational or Project Decay or Organizational or Project Prosperity and provide a format for discussing impact and adjustments. The following scenario describes how the equation was applied.

At the first meeting with the client, it was explained that the project was complex and would require considerable up-front planning and that for complex projects the company uses an Optimization Equation to guide the project toward success and prosperity. At that point, the company presented on the Optimization Equation, including a walk through of each of the components. Following the presentation, the value of using the Optimization Equation was discussed as an analogy to help explain in an efficient and effective way, complicated workforce optimization components and the balance that the integrator of these components must achieve in order to promote organizational or project prosperity.

The customer was pleased that the company had a way to assess success/failure and agreed to work with the company to apply the equation to their project. Gaining customer agreement is an important step in the process, because the company will be asking the customer to make adjustments and gaining agreement to work with the company is the first sign of customer willingness to make adjustments.

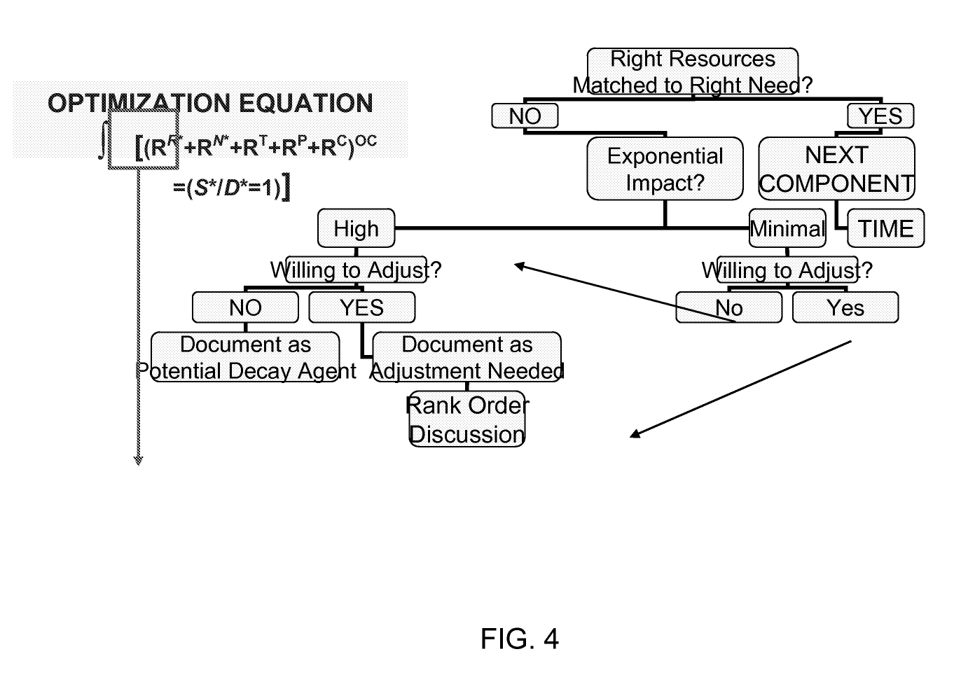

When the customer agreed to discuss the Optimization Components in light of their requirements and agreed to entertain making adjustments, a partnership was entered into with the goal of project success. This is a major step in applying the Optimization Equation, because unless the customer is willing to entertain adjustments, they are not in a partnership arrangement, and success is limited. At this point in the conversation the section of the Optimization Equation that deals with the Right Resources matched to the Right Need was focused upon. Referring to FIG. 4, a flow diagram of this process is depicted. It is first asked whether the Right Resources are matched to the Right Need. If the answer is yes, both the customer and the company have the right resources, and the process flow to the next component, which is Time. If the answer is no, then the exponential impact of not having the Right Resources matched to the Right Need is determined. Typically the exponential impact falls into two categories: minimal or high impact. At this point a description is given to the customer of what is meant by exponential: “if we don't get it right the first time, it will take twice as much effort/resources to get it right the second time; four times a much effort/resources the next time; and eight times as much effort/resources the next time and so on. If the customer is not willing to adjust even for a minimal impact, it could be a sign that this could potentially have a high impact. It is a component to watch. If they are willing to make adjustments for a minimal impact, then we can proceed to the overall priority discussion, in which we work with the customer to rank order the components requiring adjustments.

If the impact of not having the Right Resources matched to the Right Need is high and the customer is unwilling to adjust, then this component must be marked as a potential decay agent. At this point, problem areas and not solutions are being determined. If the customer is willing to adjust their resources to need requirements, then this item is documented as requiring adjustments, and tabled until overall priority discussion, in which we work with the customer to rank order the components requiring adjustments.

At this point in the analysis, it has been determined whether the project has the potential to have the Right Resources available to meet the Right Need. No decisions have been made to solve the problem: instead, we are simply documenting the state of the project using the Optimization Equation as a discussion guide that takes the emotion out of the conversation and instead makes it very methodical and straightforward.

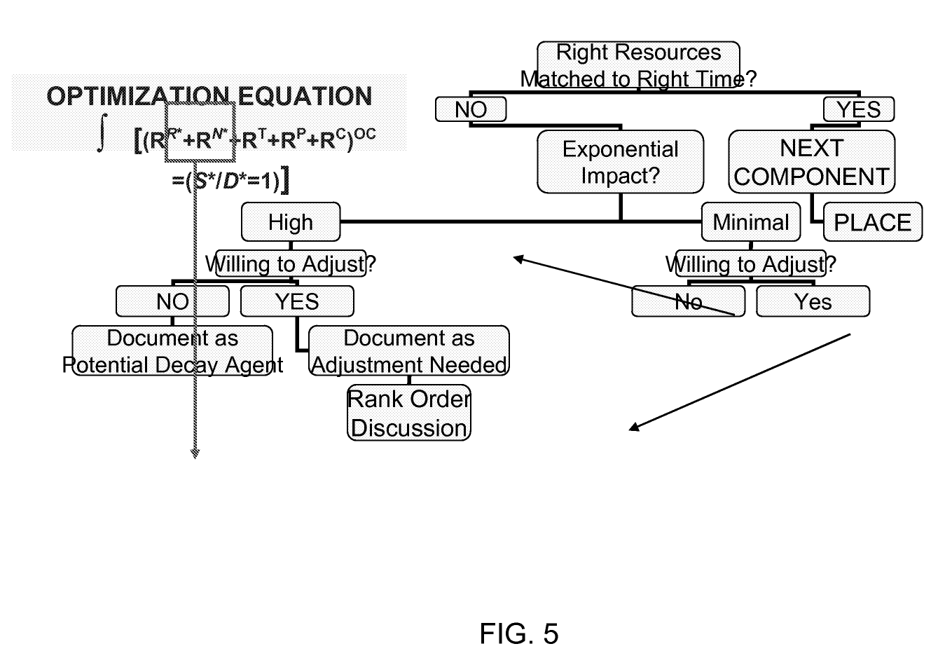

Following the Right Resources matched to the Right Need, the analysis shifts to having basically the same discussion; however, at this point, the focus is on the Time element. Referring to FIG. 5, a similar flow diagram showing the matching of the Right Resources to the Right Time is shown. If the answer is yes, both the customer and the company have the right resources available at the right time, and then we move to the next component, which is Place. If the answer is no, then we must determine the exponential impact of not having the Right Resources matched to the right Time. Typically the exponential impact falls into two categories: minimal or high impact. At this point we again give a description of what we mean by exponential: This notion of exponential impact is repeated every time in order to emphasize its importance. If the customer is not willing to adjust even for a minimal impact, it could be a sign that this could potentially have a high impact. It is a component to watch. If they are willing to make adjustments for a minimal impact, then we can proceed to the overall priority discussion, in which we work with the customer to rank order the components requiring adjustments.

If the impact of not having the Right Resources matched to the Right Time is high and the customer is unwilling to adjust, then this component must be marked as a potential decay agent. At this point, we're identifying problem areas, not determining solutions. If the customer is willing to adjust their resources based on time requirements, then this item is documented as requiring adjustments, and tabled until overall priority discussion, in which we work with the customer to rank order the components requiring adjustments.

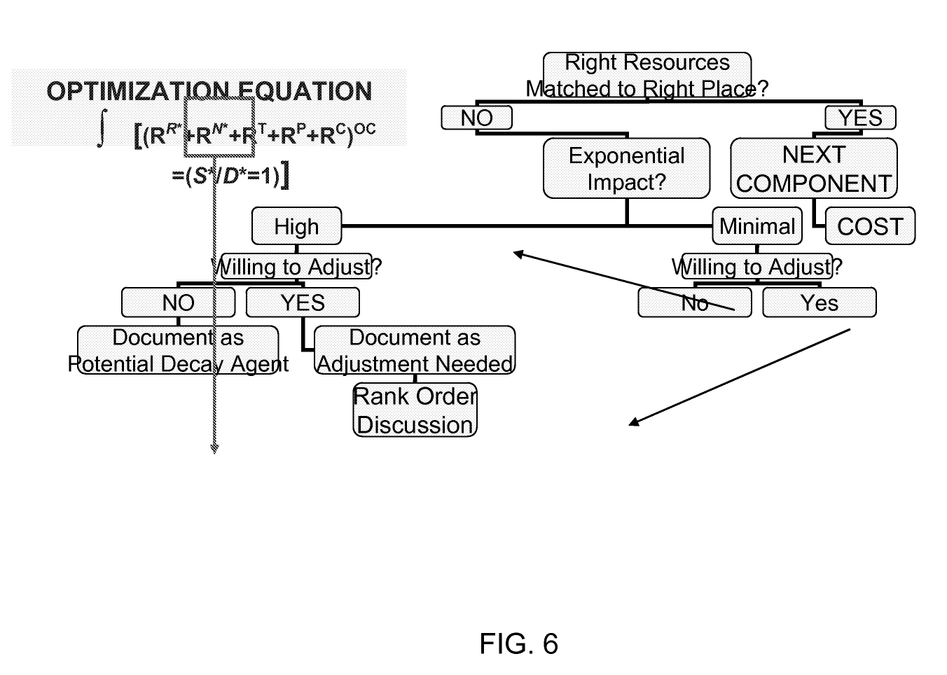

At this point in the analysis, we have determined whether or not the project has the potential to have the right resources available to meet the Right Need at the Right Time. No decisions have been made to solve the problem: instead, we are simply documenting the state of the project using the Optimization Equation as a discussion guide that takes the emotion out of the conversation and instead makes it very methodical and straightforward. Following the Right Resources matched to the Right Time, we now move to having basically the same discussion; however, at this point, we are concentrating on the Place element. Referring to FIG. 6, a flow diagram of matching the Right Resources to the Right Place is shown. If the answer is yes, both the customer and the company have the right resources available at the right Time, and then we move to the next component, which is cost. If the answer is no, then we must determine the exponential impact of not having the Right resources matched to the Right Place. Again, the exponential impact typically falls into two categories: minimal or high impact. At this point we again give a description of what we mean by exponential: This notion of exponential impact is repeated every time in order to emphasize its importance. If the customer is not willing to adjust even for a minimal impact, it could be a sign that this could potentially have a high impact. It is a component to watch. If they are willing to make adjustments for a minimal impact, then we can proceed to the overall priority discussion, in which we work with the customer to rank order the components requiring adjustments.

If the impact of not having the Right Resources matched to the Right Place is high and the customer is unwilling to adjust, then this component must be marked as a potential decay agent. At this point, we're identifying problem areas, not determining solutions. If the customer is willing to adjust their resources based on place requirements, then this item is documented as requiring adjustments, and tabled until overall priority discussion, in which we work with the customer to rank order the components requiring adjustments.

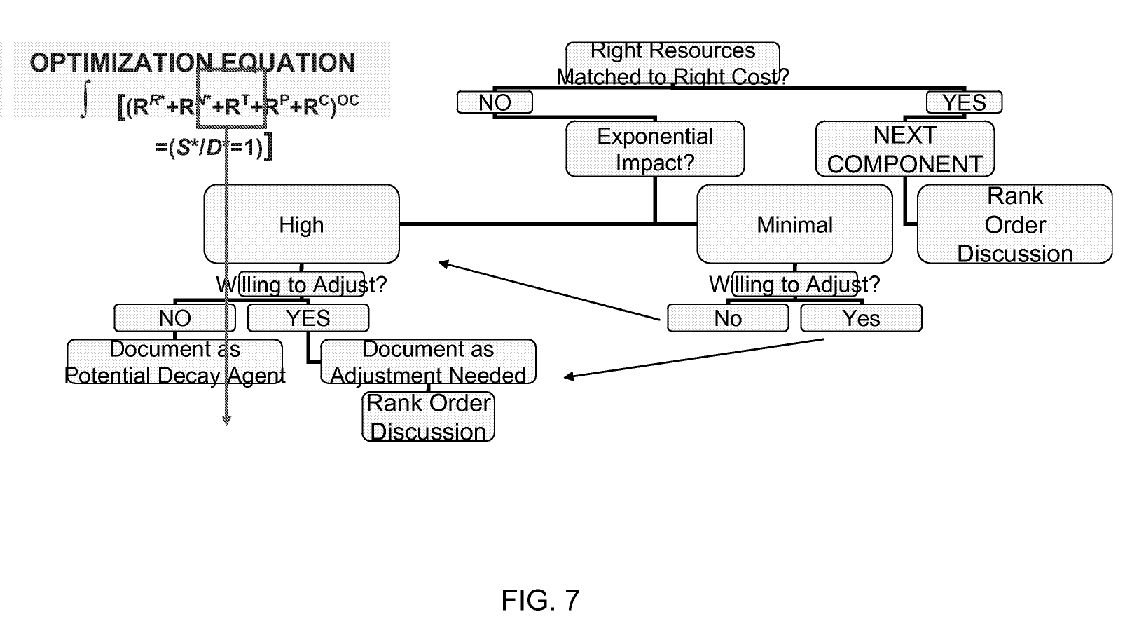

At this point in the analysis, we have now determined whether or not the project has the potential to have the Right Resources available to meet the Right Need at the Right Time and Place. No decisions have been made to solve the problem: instead, we are simply documenting the state of the project using the Optimization Equation as a discussion guide that takes the emotion out of the conversation and instead makes it very methodical and straightforward. Following the Right Resources matched to the Right Place, we now move to having basically the same discussion; however, at this point, we are concentrating on the cost element. Referring to FIG. 7, a flow diagram of matching the Right Resources to the Right Cost is shown. If the answer is yes, both the customer and the company have the right resources available at the right Cost, then we move to the next step in the conversation, which involves rank ordering the Optimization Components. If the answer is no, then we must determine the exponential impact of not having the Right resources matched at the Right Cost. Again, the exponential impact typically falls into two categories: minimal or high impact. At this point we again give a description of what we mean by exponential: This notion of exponential impact is repeated every time in order to emphasize its importance. If the customer is not willing to adjust even for a minimal impact, it could be a sign that this could potentially have a high impact. It is a component to watch. If they are willing to make adjustments for a minimal impact, then we can proceed to the overall priority discussion, in which we work with the customer to rank order the components requiring adjustments. If the impact of not having the Right Resources matched at the Right Cost is high and the customer is unwilling to adjust, then this component must be marked as a potential decay agent. At this point, we're identifying problem areas, not determining solutions. If the customer is willing to adjust their resources based on cost requirements, then this item is documented as requiring adjustments, and tabled until overall priority discussion, in which we work with the customer to rank order the components requiring adjustments.

At the meeting with the telecommunications customer, each of the components was reviewed one by one as described above, discussing each component in relation to the company's and to the customer's Supply and Demand. In this case the Demand was much greater than the Supply. This lack of balance between Supply and Demand is a key factor in creating a project that will decay. It was mutually agreed that the project would not commence until the Supply and Demand side of the equation was in balance with the “collective nature” of the resource side of the equation. This decision proved to be one of the most critical decisions and served as the turning point for both the company and the Customer to work to get it right before beginning.

Neither the company nor the customer had enough of the Right Resources to meet the Need requirement. Using the 120 work hour to build 1 hour of medium complexity web-based training, it would take 24,000 work hours to complete the project. Using a 40 hour week, it would take 600 people to complete the work in the required 8 weeks. We also needed subject matter experts from the customer (40 hours to build 1 hour of WBT) Worldwide, the customer and the company did not have enough trained resources to build and review medium complexity web-based training.

We did not have the Right Resources to meet the Time requirement. Eight weeks became the show stopper. The customer was inflexible about the time requirement. They had a federal communications mandate to complete required training in eight weeks; consequently, they had to get this training completed, else they would lose their license. Consequently, Time became the priority item. Every other component had to fall into place based on Time.

We did not have the Right Resources available to meet the Place requirement. Even if we moved every single learning developer to the same location that was the center for web-based training development for the company, there would not be enough manpower to complete the job on time. The customer was in the same predicament. They didn't have enough SMEs available at the right Place to review/revise the WBT.

For this project, cost was the least of our problems; however, the customer wanted the company to do everything in its power to bring the project in on budget, but primarily on time. Therefore, for the telecommunications project, the priority rank order for the optimization components was as follows: (1) Time, (2) Need, (3) Place, and (4) Cost. With this information agreed to between the company and the customer, we could now have meaningful discussions on what we could do to solve the customer's problem by bringing the training in on time and on budget.

Using the Optimization Equation, everyone on both sides of the table understood the components and the impact of not getting it right. We now had a strong basis to begin meaningful conversations about how to solve the problem. The customer was fully committed.

While we used a single project customer scenario to describe how the Optimization Equation could be applied to guide a single project to prosperity, the method, system, and program product could be applied to an entire organization equally as well.

### III. Computerized Implementation

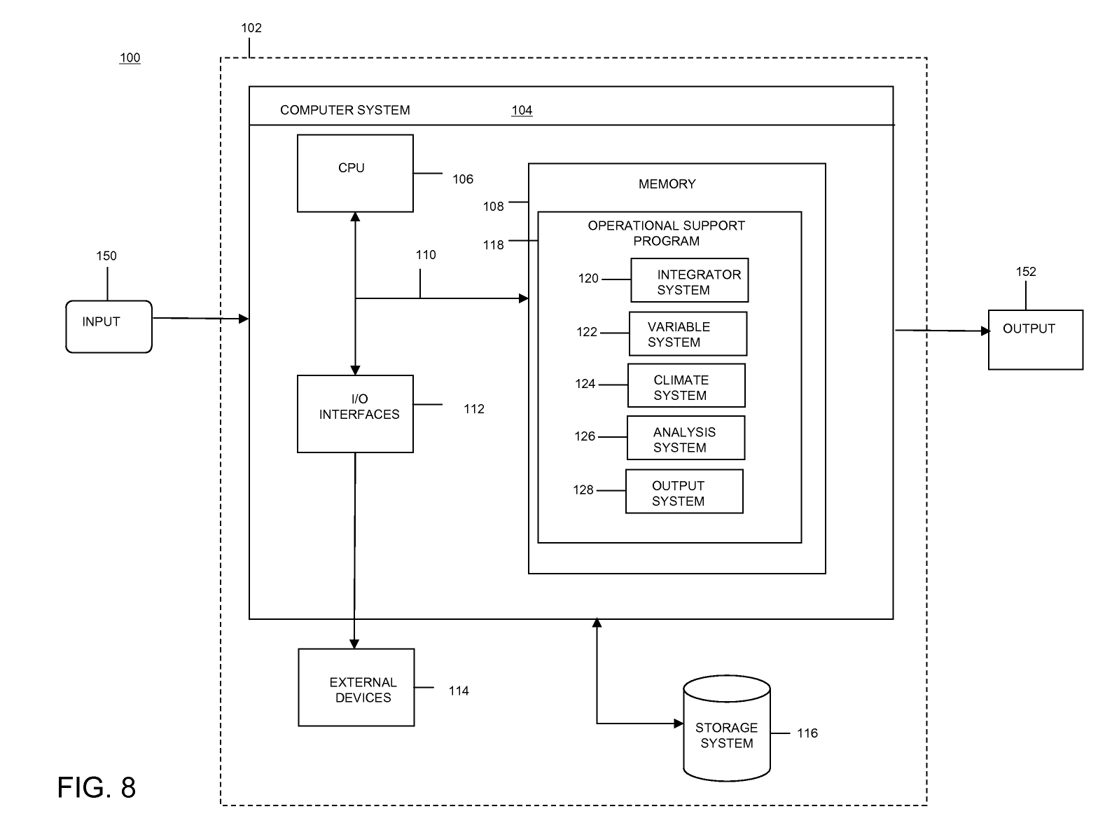

Referring now to FIG. 8, a more detailed diagram of a computerized implementation 100 of the present invention is shown. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

As shown, computer system 104 includes a processing unit 106, a memory 108, a bus 110, and input/output (I/O) interfaces 112. Further, computer system 104 is shown in communication with external I/O devices/resources 114 and storage system 116. In general, processing unit 106 executes computer program code, such as workforce optimization program 118, which is stored in memory 108 and/or storage system 116. While executing computer program code, processing unit 106 can read and/or write data to/from memory 108, storage system 116, and/or I/O interfaces 112. Bus 110 provides a communication link between each of the components in computer system 104. External devices 114 can comprise any devices (e.g., keyboard, pointing device, display, etc.) that enable a user to interact with computer system 104 and/or any devices (e.g., network card, modem, etc.) that enable computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the process(es) of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, I/O interfaces 112 can comprise any system for exchanging information with one or more external device 114. Still further, it is understood that one or more additional components (e.g., system software, math co-processing unit, etc.) not shown in FIG. 8 can be included in computer system 104. However, if computer system 104 comprises a handheld device or the like, it is understood that one or more external devices 114 (e.g., a display) and/or storage system 116 could be contained within computer system 104, not externally as shown.

Storage system 116 can be any type of system (e.g., a database) capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104. It should be understood computer system could be any combination of human, hardware and/or software. It is shown as such to illustrate the functions as described herein.

Shown in memory 108 of computer system 104 is workforce optimization program 118, which facilitates the functions as described herein. As depicted, workforce optimization program 118 includes integrator system 120, variable system 122, climate system 124, analysis system 126, and output system. It should be understood that this configuration of functionality is intended to be illustrative only, and that identical or similar functionality could be provided with a different configuration of systems.

In any event, workforce optimization program 118 facilitates the functions as described herein. Specifically, integrator system 120 is configured allow an integrator within an organization to be designated (e.g., based on input 150). Variable system 122 is configured to used input 150 to assign values to the workforce variables described above in the workforce optimization equation. Climate system 124 is configured to use input 150 to determine and set forth the organizational climate of the organization. Analysis system 126 is configured to process this information and follow the steps set forth above (e.g., in FIGS. 4-7 and in the illustrative example with respect to analyzing the workforce variables. Output system 128 is configured to generate any desired output such as graphs, conclusions, recommendations, etc.

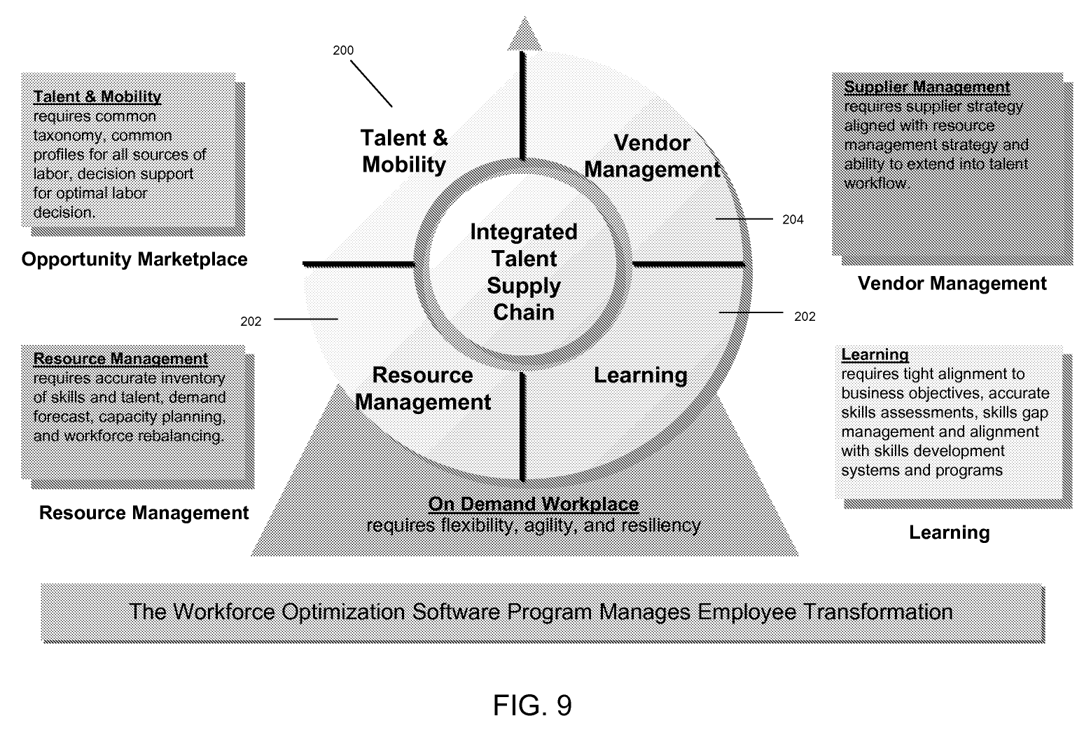

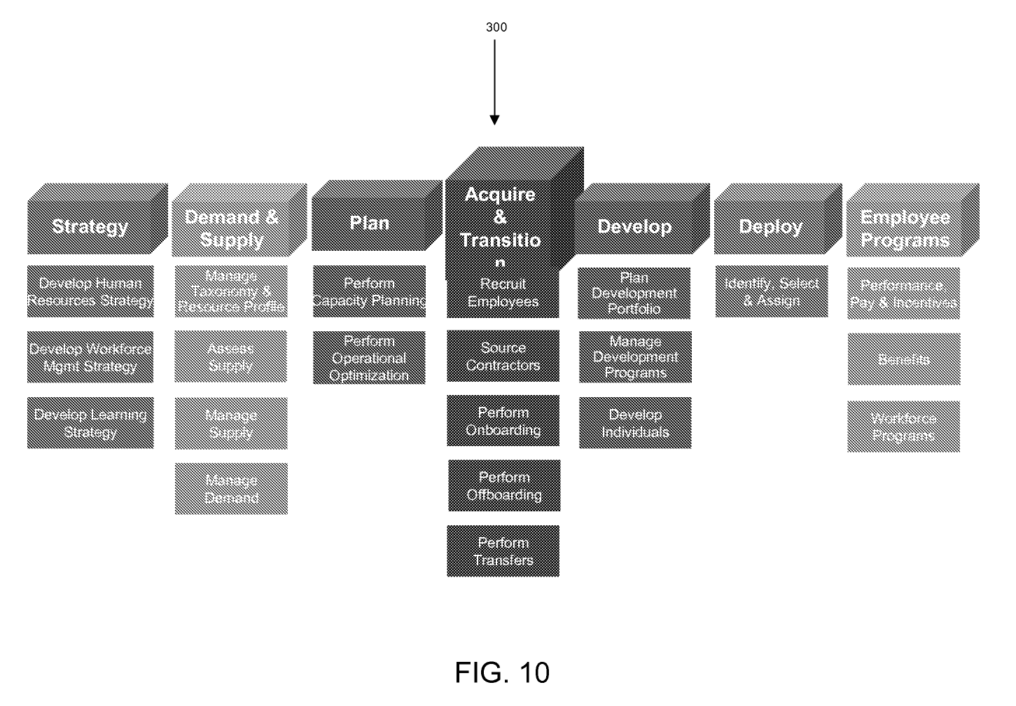

Referring to FIG. 9, it can be seen that the present invention joins several key areas such as talent and mobility 200, resource management 202, learning 204, and supplier management 206. Referring to FIG. 10, a set of components that are provided by the present invention is shown. For brevity, some of these components might not have previously been depicted. However, it should be understood that one or more of components 300 could be implemented within workforce optimization program 118 of FIG. 8 (if not already shown). As can be seen, components 300 cover several important areas such as strategy, demand and supply, planning, acquisition and transition, development, deployment, and employee programs.

While shown and described herein as a method and system for optimizing a workforce, it is understood that the invention further provides various alternative embodiments. For example, in one embodiment, the invention provides a computer-readable/useable medium that includes computer program code to enable a computer infrastructure to optimize a workforce. To this extent, the computer-readable/useable medium includes program code that implements the process(es) of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 8) and/or storage system 116 (FIG. 8) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to optimize a workforce. In this case, the service provider can create, maintain, support, etc., a computer infrastructure, such as computer infrastructure 102 (FIG. 8) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for optimizing a workforce. In this case, a computer infrastructure, such as computer infrastructure 102 (FIG. 8), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 8), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for optimizing a workforce for an organization, comprising:
determining a set of workforce variables;
determining an organizational climate of the organization;
interrelating the set of workforce variables and the organizational climate in an equation; and
optimizing the workforce based on the equation.

2. The method of claim 1, the set of organizational variables comprising: a right resource, a right need, a right time, a right place, and a right cost.

3. The method of claim 1, further comprising designating an integrator within the organization who is responsible for integrating the set of workforce.

4. The method of claim 1, the workforce being optimized when the equation equals a value of 1.0.

5. The method of claim 1, the workforce being optimized when ratio of workforce supply to workforce demand equals a value of 1.0.

6. The method of claim 1, the organizational climate relating to a satisfaction level of the workforce.

7. A system for optimizing a workforce for an organization, comprising:
a system for determining a set of workforce variables;
a system for determining an organizational climate of the organization;
a system for interrelating the set of workforce variables and the organizational climate in an equation; and
a system for optimizing the workforce based on the equation.

8. The system of claim 7, the set of organizational variables comprising: a right resource, a right need, a right time, a right place, and a right cost.

9. The system of claim 7, further comprising a system for designating an integrator within the organization who is responsible for integrating the set of workforce.

10. The system of claim 7, the workforce being optimized when the equation equals a value of 1.0.

11. The system of claim 7, the workforce being optimized when ratio of workforce supply to workforce demand equals a value of 1.0.

12. The system of claim 7, the organizational climate relating to a satisfaction level of the workforce.

13. A program product stored on a computer readable medium for optimizing a workforce for an organization, the computer readable medium comprising instructions for causing a computer system to:
determine a set of workforce variables;
determine an organizational climate of the organization;
interrelate the set of workforce variables and the organizational climate in an equation; and
optimizing the workforce based on the equation.

14. The program product of claim 13, the set of organizational variables comprising: a right resource, a right need, a right time, a right place, and a right cost.

15. The program product of claim 13, the computer readable medium further comprising instructions for causing the computer system to: designate an integrator within the organization who is responsible for integrating the set of workforce.

16. The program product of claim 13, the workforce being optimized when the equation equals a value of 1.0.

17. The program product of claim 13, the workforce being optimized when ratio of workforce supply to workforce demand equals a value of 1.0.

18. The program product of claim 13, the organizational climate relating to a satisfaction level of the workforce.

19. A method for optimizing a workforce for an organization, comprising:
deploying a computer infrastructure being operable to:
determine a set of workforce variables;
determine an organizational climate of the organization;
interrelate the set of workforce variables and the organizational climate in an equation; and
optimizing the workforce based on the equation.

20. The method of claim 19, the set of organizational variables comprising: a right resource, a right need, a right time, a right place, and a right cost.

21. The method of claim 19, the computer infrastructure being further operable to: designate an integrator within the organization who is responsible for integrating the set of workforce.

22. The method of claim 19, the workforce being optimized when the equation equals a value of 1.0.

23. The method of claim 19, the workforce being optimized when ratio of workforce supply to workforce demand equals a value of 1.0.

24. The method of claim 19, the organizational climate relating to a satisfaction level of the workforce.
